(19) United States
(12) Patent Application Publication
(10) Pub. No.: US 2009/0053932 A1
(43) Pub. Date: Feb. 26, 2009

(54) SLIM USB MALE CONNECTOR

(75) Inventors: JIA-GUI ZHOU, Shenzhen City (CN); SHIN-HONG CHUNG, Tu-Cheng (TW); XIAO-GUANG LI, Shenzhen City (CN); KUAN-HONG HSIEH, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (SHENZHEN) CO., LTD., Shenzhen City (CN); HON HAI PRECISION INDUSTRY CO., LTD., Tu-Cheng (TW)

(21) Appl. No.: 12/193,764

(22) Filed: Aug. 19, 2008

(30) Foreign Application Priority Data
Aug. 24, 2007 (CN) 200710076574.7

(51) Int. Cl. H01R 13/648

(52) U.S. Cl. 439/607

(57) ABSTRACT

The invention relates to a slim USB male connector. In one embodiment, the USB male connector includes an insulating base portion, a plurality of contact terminals, and a grounding plate. The base portion includes a top surface and a bottom surface and is capable of being inserted into a standard USB female connector. The contact terminals are mounted on the upper surface and are elastically deformed after the base portion is inserted into a standard USB female connector. The grounding plate is mounted on the bottom surface and is capable of contacting tongues of a standard USB female connector to achieve system grounding.

### BACKGROUND

1. Technical Field

The present invention relates to USB connectors, more specifically, to a slim USB male connector with contact terminals elastically deformed after the USB male connector is inserted into a standard USB female connector.

2. General Background

The Universal Serial Bus (USB) is a useful way to connect many peripherals together. It is becoming increasingly important in today's electronics world. One of the reasons that USB was created was to replace existing serial and parallel ports on computers. USB has several advantages over those old connection ports.

A USB male connector usually has a metal housing made by stamping. The metal housing complies with USB-IF grounding requirements by grounding with a computer via a USB female connector into which the USB male connector is inserted.

However, due to the metal housing, the size of the USB male connector can not be minimized. When the USB male connector is inserted into a stacked USB female connector, it could be too close to the neighbor USB male connectors, thus making connecting and disconnecting maneuvers difficult. The slim design of the USB connector is also restricted by the housing and the housing becomes an obstacle to slim design.

Accordingly, there is a need to provide a slim USB male connector to solve the foregoing problems.

### SUMMARY

The invention relates to a slim USB male connector. In one embodiment, the USB male connector includes an insulating base portion, a plurality of contact terminals, and a grounding plate. The base portion includes a top surface and a bottom surface and is capable of being inserted into a standard USB female connector. The contact terminals are mounted on the upper surface and are elastically deformed after the base portion is inserted into a standard USB female connector. The grounding plate is mounted on the bottom surface and is capable of contacting tongues of a standard USB female connector to achieve system grounding.

Other features and advantages will be or become apparent to one with skill in the art upon examination of the accompanying drawings and detailed description. It is intended that all such additional systems, methods, features, and advantages be included within this description, be within the scope of the present invention, and be protected by the accompanying claims.

### BRIEF DESCRIPTION OF THE DRAWINGS

The components of the drawings are not necessarily drawn to scale, the emphasis instead being placed upon clearly illustrating the principles of a USB male connector. Moreover, in the drawings, like reference numerals designate corresponding parts throughout several views.

FIG. 1 is an isometric view of a USB male connector in accordance with one exemplary embodiment of the present invention.

FIG. 2 is similar to FIG. 1, but showing a view from another aspect.

FIG. 3 is an isometric view of a contact terminal of the USB male connector of FIG. 1.

FIG. 4 is an isometric view of a connector assembly, which shows that the USB male connector inserts into a standard USB female connector.

FIG. 5 is a cross-sectional view of the connector assembly of FIG. 4, taken along the line V-V in FIG. 4.

### DETAILED DESCRIPTION OF THE EMBODIMENTS

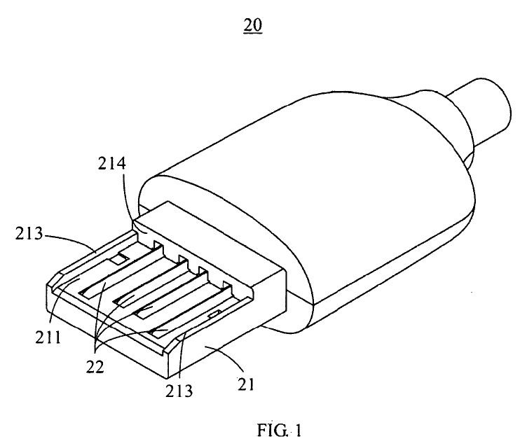

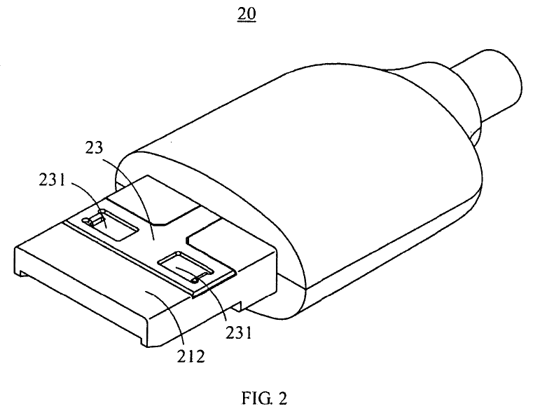

FIGS. 1 and 2 show a USB male connector 20 in accordance with an exemplary embodiment of the present invention. The USB male connector 20 includes a base portion 21, four contact terminals 22, and a metal grounding plate 23.

The base portion 21 is constructed of electrically insulating material, such as molded plastic. The base portion 21 includes a top surface 211, a bottom surface 212, and a pair of guide rails 213.

The guide rails 213 are formed at a left side and a right side of the top surface 211 and are used for preventing an erroneous insertion of the base portion 21. The guide rails 213 extend all length of the top surface 211, which extends, from a front edge of the top surface 211, all the way to a vertical wall 214.

The contact terminals 22 are mounted on the base portion 21 and are protruded out of the top surface 211. In the exemplary embodiment of FIG. 1, the four contact terminals 22 are formed integrally within the base portion 21 by injection molding. The arrangement and configuration of the four contact terminals 22 complies with the USB specification.

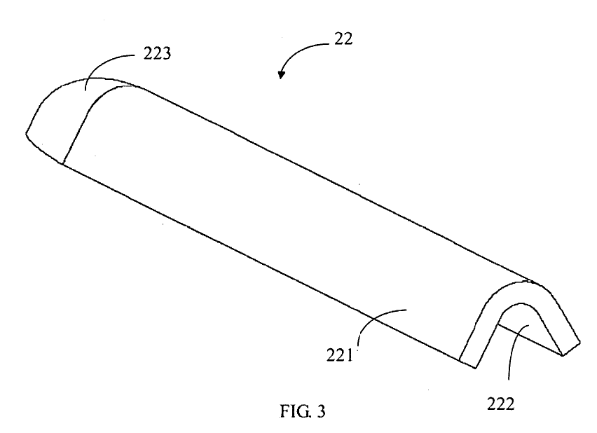

Referring to FIG. 3, each of the four contact terminals 22 is constructed of thin sheet metal by stamping and has a convex arc shape cross section. In the illustrated embodiment, the sheet metal has a thickness of about 0.1 to 0.15 mm. Each of the contact terminals 22 includes a first side wall 221 and a second side wall 222. The angle between the first side wall 221 and the second side wall is about 45° to 60°.

In the process of inserting the USB male connector 20 into a standard USB female connector, a front end 223 of the contact terminal 22 contacts a corresponding terminal of the standard USB female connector first. Thus, to facilitate inserting of the USB male connector 20, the front end 223 is constructed to be in the form of a smooth curved surface.

The metal grounding plate 23 is mounted on the base portion 21 at the bottom surface 212 side. The grounding plate 23 is used for contacting tongues of a standard USB female connector for achieving system grounding. The grounding plate 23 includes two spaced openings 231.

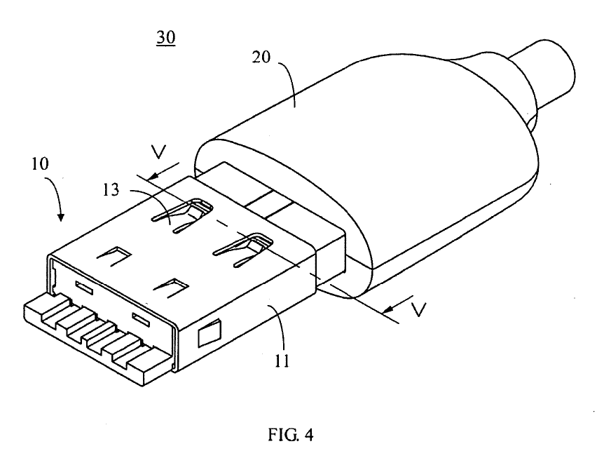

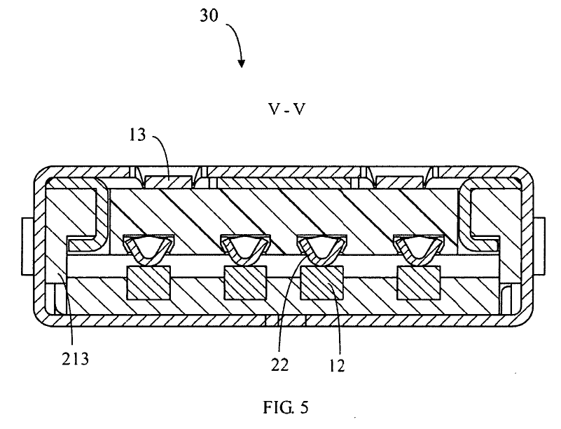

FIGS. 4 and 5 show that the USB male connector 20 inserts into a standard USB female connector 10. The standard USB female connector 10 includes a metal housing 11 and four terminals 12. The metal housing 11 includes two downwardly extended elastic tongues 13. The four terminals are disposed within the housing 11.

In the process of inserting the USB male connector 20 into the USB female connector 10, the grounding plate 23 contacts the two tongues 13, and the two tongues 13 are pushed upwardly until that ends of the two elastic tongues 13 are fully received in the two openings 231 of the grounding plate 23.

After the USB male connector 20 is inserted into the USB female connector 10, the contacts terminals 22 contact the terminals 12 and are elastically deformed by the force applied by the terminals 12.

The USB male connector 20 is formed without a conventional metal housing, achieving a minimized thickness. The elastically deformable contact terminals 22 strengthen the mechanical connection between the USB male connector 20 and the USB female connector 10.

Although the present invention has been specifically described on the basis of an exemplary embodiment, the invention is not to be construed as being limited thereto. Various changes or modifications may be made to the exemplary embodiment without departing from the scope and spirit of the invention.

What is claimed is:

1. A slim USB male connector comprising:
an insulating base portion comprising a top surface and a bottom surface, and being configured for being inserted into a standard USB female connector;
a plurality of contact terminals, mounted on the upper surface, capable of being elastically deformed after the base portion being inserted into the standard USB female connector; and
a grounding plate, mounted on the bottom surface, configured for contacting tongues of the standard USB female connector to achieve system grounding.

2. The slim USB male connector according to claim 1, wherein the base portion comprises two guide rails, which are formed on the top surface of the base portion for preventing an erroneous insertion of the base portion.

3. The slim USB male connector according to claim 1, wherein the grounding plate comprises openings for receiving ends of tongues of the standard USB female connector.

4. The slim USB male connector according to claim 1, wherein the plurality of contact terminals are formed integrally within the base portion.

5. The slim USB male connector according to claim 1, wherein each of the terminals has an end with a curved surface for ease of insertion into the standard USB female connector.

6. The slim USB male connector according to claim 1, wherein each of the contact terminals has a cross section of convex arc shape.

7. The slim USB male connector according to claim 1, wherein the insulating base portion is made of molded plastic.

8. The slim USB male connector according to claim 1, wherein each of the plurality of contact terminals has a thickness of about 0.1 to 0.15 mm.
